(19) United States
(12) Patent Application Publication
(10) Pub. No.: US 2016/0337926 A1
(43) Pub. Date: Nov. 17, 2016

(54) METHOD TO IMPROVE CHANNEL SCANNING ALGORITHM FOR BETTER SYSTEM PERFORMANCE IN MULTI RAT DEVICES

(71) Applicant: QUALCOMM Incorporated, San Diego, CA (US)

(72) Inventors: Bhaskara Viswanadham Batchu, Hyderabad (IN); Aditya Kailash Bohra, Gujarat (IN); Sharad Shahi, Boulder, CO (US)

(21) Appl. No.: 14/709,142

(22) Filed: May 11, 2015

(51) Int. Cl. H04W 36/30

(52) U.S. Cl. CPC H04W 36/30

(57) ABSTRACT

A method for channel scanning includes: accessing a communication network with a first subscription on a first band and channel combination using a first pseudorandom noise (PN) code; determining if channel quality on the first band and channel combination using the first PN code has deteriorated; in response to determining that the channel quality has deteriorated, determining if a good sector is available on the first band and channel combination; in response to determining that a good sector is available, preventing the first band and channel combination from being placed on an avoidance list; and handing off to the good sector using a second PN code.

### BACKGROUND

A multi-subscriber identity module (SIM) multi-standby (MSMS) mobile communication device shares a single radio frequency (RF) chain among the radio access technologies (RATs) used by the mobile communication device. On some networks, access handoffs for a particular RAT (e.g., code division multiple access (CDMA) or another RAT) may be disabled. When access handoffs are disabled, the subscription associated with the particular RAT may be compelled to stay on a sector having poor channel quality.

Under poor channel conditions, the subscription may be unable to receive or send messages to the base station which may lead to an access failure or MAPE (Max Access Probe Exit). When MAPE or access timeout occurs, the current band and channel is put in an avoidance list for a period of time. While the band and channel is in the avoidance list, the mobile communication device is prevented from attempting to access the network on that band and channel. The subscription then goes into acquisition mode and tries to reacquire the system on different channels.

The mobile communication device may search for a signal having a power level above a threshold power level (i.e., a “good” channel). Several seconds may be required for the subscription to complete acquisition and return to service when an acquisition attempt is made on the good channel. However, if there are no good channels available, the subscription may be stuck in Out of Service (OOS) mode which hampers performance of the subscription and as well as subscriptions associated with other RATs supported by the MSMS mobile communication device. When a subscription is stuck in OOS mode, the mobile communication device may experience mobile terminated call failures and system failures for the all subscriptions since the shared RF resources are monopolized by the OOS subscription.

### SUMMARY

Apparatuses and methods for channel scanning for a mobile communication device are provided.

According to various embodiments there is provided a method for channel scanning. In some embodiments, the method may include: accessing a communication network with a first subscription on a first band and channel combination using a first pseudorandom noise (PN) code; determining if channel quality on the first band and channel combination using the first PN code has deteriorated; in response to determining that the channel quality has deteriorated, determining if a good sector is available on the first band and channel combination; in response to determining that a good sector is available, preventing the first band and channel combination from being placed on an avoidance list; and handing off to the good sector using a second PN code.

According to various embodiments there is provided a mobile communication device. In some embodiments, the mobile communication device may include: a communication unit; and a control unit.

The control unit may be configured to: cause the communication unit to access a communication network with a first subscription on a first band and channel combination using a first pseudorandom noise (PN) code; determine if channel quality on the first band and channel combination using the first PN code has deteriorated; in response to determining that the channel quality has deteriorated, determine if a good sector is available on the first band and channel combination; in response to determining that a good sector is available, prevent the first band and channel combination from being placed on an avoidance list; and cause the communication unit to hand off to the good sector using a second PN code.

According to various embodiments there is provided a non-transitory computer readable medium. In some embodiments, the non-transitory computer readable medium may include instructions for causing one or more processors to perform operations including: accessing a communication network with a first subscription on a first band and channel combination using a first pseudorandom noise (PN) code; determining if channel quality on the first band and channel combination using the first PN code has deteriorated; in response to determining that the channel quality has deteriorated, determining if a good sector is available on the first band and channel combination; in response to determining that a good sector is available, preventing the first band and channel combination from being placed on an avoidance list; and handing off to the good sector using a second PN code.

According to various embodiments there is provided an apparatus. In some embodiments, the apparatus may include: means for accessing a communication network with a first subscription on a first band and channel combination using a first pseudorandom noise (PN) code; means for determining if channel quality on the first band and channel combination using the first PN code has deteriorated; means for in response to determining that the channel quality has deteriorated, determining if a good sector is available on the first band and channel combination; means for in response to determining that a good sector is available, preventing the first band and channel combination from being placed on an avoidance list; and means for handing off to the good sector using a second PN code.

Other features and advantages of the present inventive concept should be apparent from the following description which illustrates by way of example aspects of the present inventive concept.

### BRIEF DESCRIPTION OF THE DRAWINGS

Aspects and features of the present inventive concept will be more apparent by describing example embodiments with reference to the accompanying drawings, in which:

FIG. 1 is a block diagram illustrating a mobile communication device according to various embodiments;

FIG. 2 is a flowchart illustrating a method according to various embodiments; and

FIG. 3 is a flowchart illustrating a method according to various embodiments.

### DETAILED DESCRIPTION

While certain embodiments are described, these embodiments are presented by way of example only, and are not intended to limit the scope of protection. The apparatuses, methods, and systems described herein may be embodied in a variety of other forms. Furthermore, various omissions, substitutions, and changes in the form of the example methods and systems described herein may be made without departing from the scope of protection.

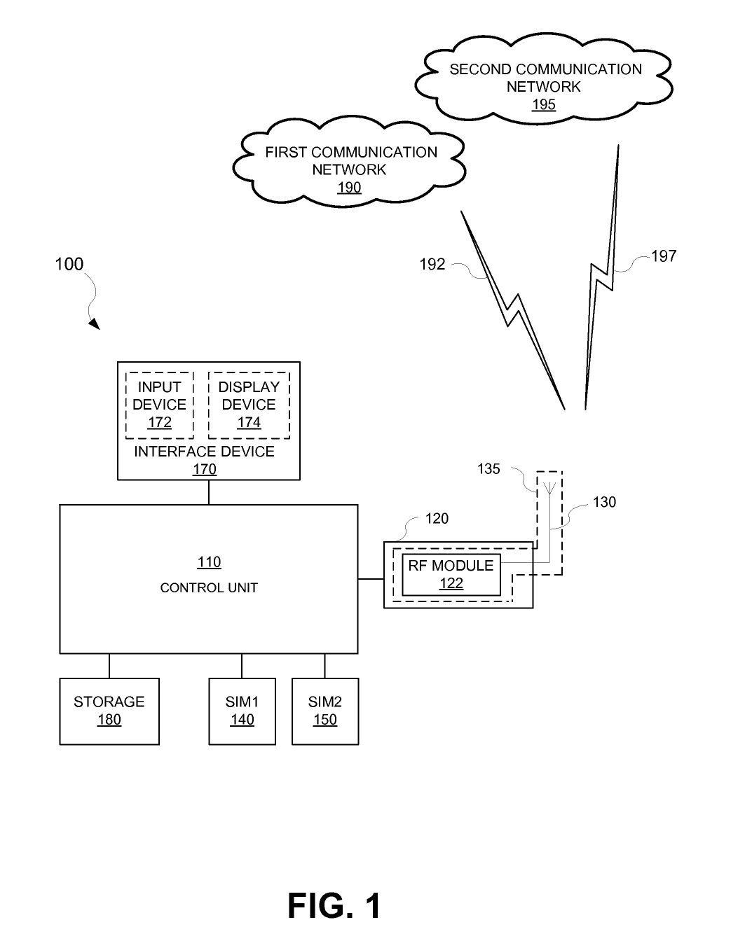

FIG. 1 is a block diagram illustrating a mobile communication device 100 according to various embodiments. As illustrated in FIG. 1, the mobile communication device 100 may include a control unit 110, a communication unit 120, an antenna 130, a first SIM 140, a second SIM 150, a user interface device 170, and a storage 180.

The mobile communication device 100 may be, for example but not limited to, a mobile telephone, smartphone, tablet, computer, etc., capable of communications with one or more wireless networks. One of ordinary skill in the art will appreciate that the mobile communication device 100 may include one or more transceivers (communications units) and may interface with one or more antennas without departing from the scope of the present inventive concept.

The communication unit 120 may include, for example, but not limited to, an RF module 122. The RF module 122 may include, for example, but not limited to a first transceiver (not shown). An RF chain 135 may include, for example, but not limited to the antenna 130 and the RF module 122.

The first SIM 140 may associate the communication unit 120 with a first subscription (Sub1) 192 on a first communication network 190 and the second SIM 150 may associate the communication unit 120 with a second subscription (Sub2) 197 on a second communication network 195. One of ordinary skill in the art will appreciate that either subscription may be a data and/or voice subscription without departing from the scope of the present inventive concept. Further, one of ordinary skill in the art will appreciate that while various embodiments are described in terms of a dual-SIM dual-standby (DSDS) mobile communication device for convenience, the present inventive concept may be extended to MSMS mobile communication devices.

The first communication network 190 and the second communication network 195 may be operated by the same or different service providers, and/or may support the same or different radio access technologies (RATs), for example, but not limited to, GSM, CDMA, WCDMA, and LTE.

The user interface device 170 may include an input device 172, for example, but not limited to a keyboard, touch panel, or other human interface device, and a display device 174, for example, but not limited to, a liquid crystal display (LCD), light emitting diode (LED) display, or other video display. One of ordinary skill in the art will appreciate that other input and display devices may be used without departing from the scope of the present inventive concept.

The control unit 110 may be configured to control overall operation of the mobile communication device 100 including control of the communication unit 120, the user interface device 170, and the storage 180. The control unit 110 may be a programmable device, for example, but not limited to, a microprocessor (e.g., general-purpose processor, baseband modem processor, etc.) or microcontroller.

The storage 180 may be configured to store application programs for operation of the mobile communication device 100 that are executed by the control unit 110, as well as application data and user data.

For some RATs, a band-channel combination may be composed of a channel indicated by a channel center frequency within a frequency band, and various pseudorandom (PN) codes may be transmitted within the channel. Different PN codes may be transmitted from different sectors within a cell served by the same base station. Each mobile communication device 100 may communicate with the base station using different PN codes. One of ordinary skill in the art will appreciate that other band and channel combinations may be possible for other RATs without departing from the scope of the present inventive concept. When access handoff is disabled and a MAPE or fade timeout occurs on a RAT (e.g., CDMA or another RAT) the mobile communication device 100 may transition to idle mode.

While in idle mode, the mobile communication device 100 may determine if there are any good sectors available on a same base station. For example, the mobile communication device 100 may search for a signal having a power level above a threshold power level from another sector (i.e., a “good” sector) on a first band and channel combination. A good sector may have a different PN code on the first band and channel combination in use by the mobile communication device 100. If there is a good sector available to handoff or sustain the service, the mobile communication device 100 may cause the RAT to handoff to that sector and not put the first band and channel combination in the avoidance list. The control unit 110 may cause Sub1 192 to handoff to the new sector having a second PN code and avoid causing the mobile communication device 100 going back to initialization on Sub1 192. The access state may then be used to collect the over-the-air system messages (OTAs) if needed using the second PN code.

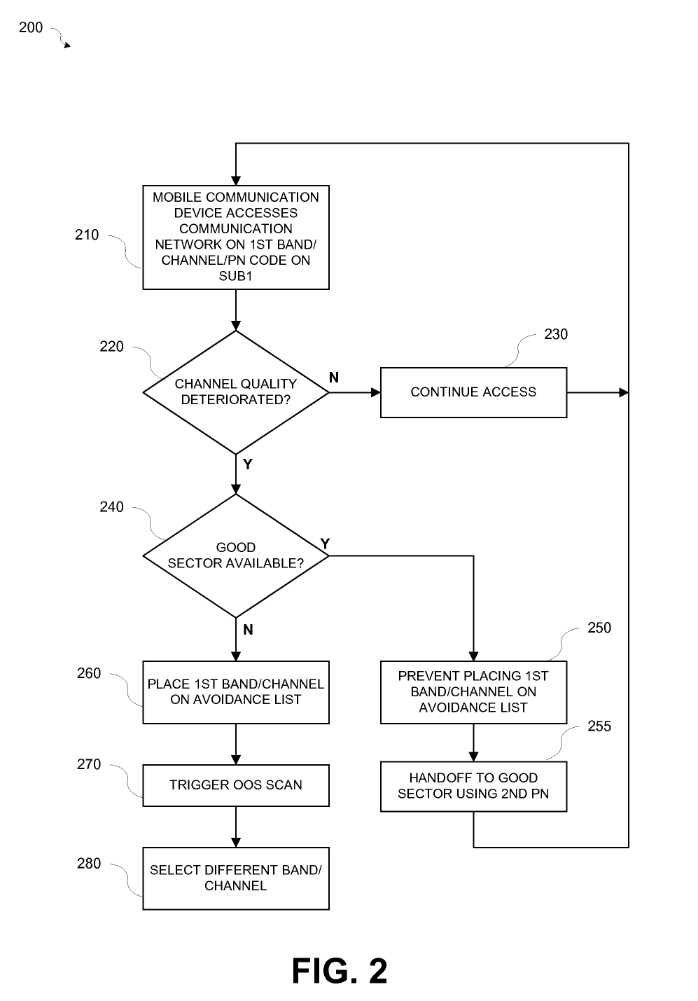

FIG. 2 is a flowchart illustrating a method 200 according to various embodiments. Referring to FIGS. 1 and 2, the mobile communication device 100 may access a communication network (e.g., the first communication network 190) on a first channel in a first frequency band (i.e., a first band and channel combination) using a first PN code on one subscription (e.g., Sub1 192) (210). In some embodiments, Sub1 192 may be a CDMA subscription (or another subscription). The control unit 110 may determine if channel quality has deteriorated. For example, a MAPE or access timeout may occur. When the control unit 110 determines that the channel quality has not deteriorated, the mobile communication device 100 may continue to access the first communication network 190 on the first band and channel combination using the first PN code.

When the control unit 110 determines that the channel quality has deteriorated (e.g., a MAPE or access timeout has occurred due to received signal power or other channel quality indicator falling below a threshold value) with access handoff disabled (220—Y), the control unit 110 may determine whether any good sectors served by the same base station are available (240). For example, the mobile communication device 100 may transition to idle mode on Sub1 192. The control unit 110 may cause the communication unit 120 to search for other PN codes to determine if any good sectors served by the same base station are available. For instance, for a CDMA RAT (or other RAT) a good sector may be a sector served by the same base station having a received signal power above a threshold level on the same channel but using a different PN code.

When a good sector is available (240—Y), the control unit 110 may prevent the first band and channel combination from being placed on the avoidance list (250). The control unit 110 may cause the communication unit 120 to handoff to the good sector on the first subscription 192 using a second PN code (255).

If a good sector is not available (240—N), the control unit 110 may place the first band and channel combination on the avoidance list (260). The control unit 110 may trigger the communication unit 120 to perform an OOS scan (270). Based on the results of the 00S scan, the control unit 110 may select a different band and channel combination to access the first communication network 190 (280).

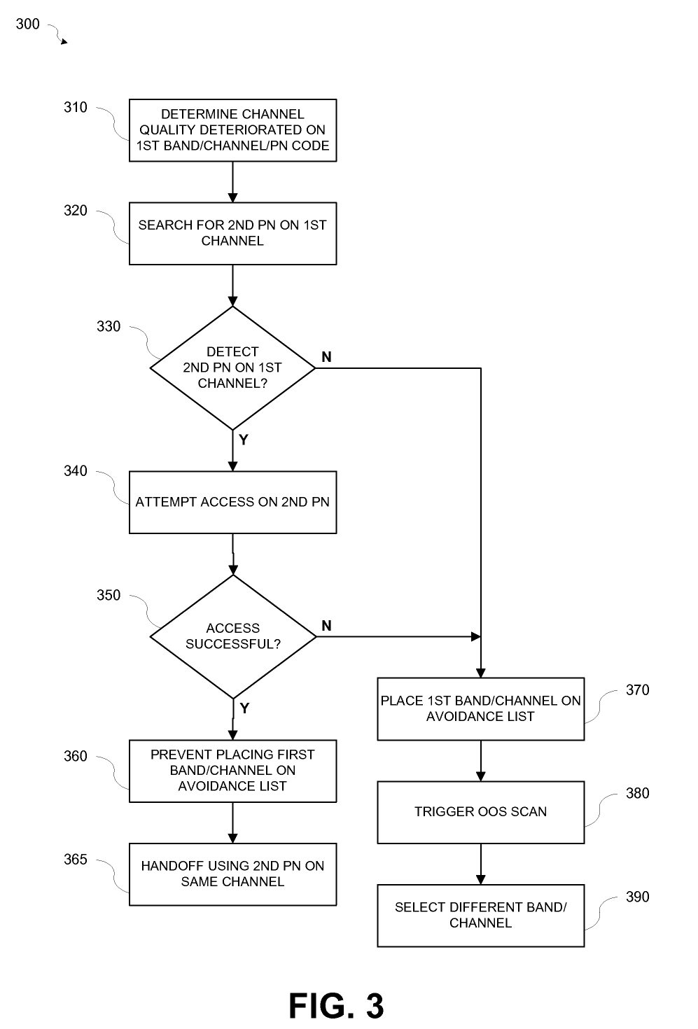

FIG. 3 is a flowchart illustrating a method 300 according to various embodiments. Referring to FIGS. 1-3, the mobile communication device 100 may be connected to a network (e.g., the first communication network 190) on a first subscription (e.g., Sub1 192) on a first band and channel combination using a first PN code. The control unit 110 may determine that the channel quality on the first band and channel combination using the first PN code has deteriorated (310). For example, the received signal power or other channel quality indicator may fall below a threshold value. The control unit 110 may cause the communication unit 120 to search for a second PN code on the first band and channel combination (320). For example, the control unit 110 may search for a second PN code of a sector having a received signal power above a threshold level served by the same base station.

If the communication unit 120 detects the second PN code on the first band and channel combination (330—Y), the communication unit 120 may attempt to access the first communication network 190 on Sub1 192 using the second PN code (340). If the access attempt is successful (350—Y), the control unit 110 may prevent the first band and channel combination from being placed on the avoidance list (360). The control unit 110 may cause the mobile communication device 100 to handoff to the sector using the second PN code on the first band and channel combination (365).

If the communication unit 120 does not detect the second PN code on the first band and channel combination (330—N), or if the communication unit 120 detects the second PN code on the first band and channel combination but the access attempt is not successful (350—N), the control unit 110 may place the first band and channel combination on the avoidance list (370). The control unit 110 may trigger an OOS scan (380). Based on the results of the OOS scan, the control unit 110 may select a different band and channel to access the first communication network 190 (390).

The methods 200 and 300 described with respect to FIGS. 2 and 3, respectively, may be embodied on a non-transitory computer readable medium, for example, but not limited to, the storage 180 or other non-transitory computer readable medium known to those of skill in the art, having stored therein a program including computer executable instructions for making a processor, computer, or other programmable device execute the operations of the methods.

The accompanying claims and their equivalents are intended to cover such forms or modifications as would fall within the scope and spirit of the protection. For example, the example apparatuses, methods, and systems disclosed herein can be applied to multi-SIM wireless devices subscribing to multiple communication networks and/or communication technologies. The various components illustrated in the figures may be implemented as, for example, but not limited to, software and/or firmware on a processor, ASIC/FPGA/DSP, or dedicated hardware. Also, the features and attributes of the specific example embodiments disclosed above may be combined in different ways to form additional embodiments, all of which fall within the scope of the present disclosure.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an,” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present inventive concept.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in processor-executable instructions that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

Although the present disclosure provides certain example embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

What is claimed is:

1. A method for channel scanning, the method comprising:
accessing a communication network with a first subscription on a first band and channel combination using a first pseudorandom noise (PN) code;
determining if channel quality on the first band and channel combination using the first PN code has deteriorated;
in response to determining that the channel quality has deteriorated, determining if a good sector is available on the first band and channel combination;
in response to determining that a good sector is available, preventing the first band and channel combination from being placed on an avoidance list; and
handing off to the good sector using a second PN code.

2. The method of claim 1, further comprising:
in response to determining that a good sector is not available, placing the first band and channel combination on the avoidance list;
performing an out-of-service scan; and
selecting a different band and channel combination to access the communication network with the first subscription.

3. The method of claim 2, wherein the determining if a good sector is available on the first band and channel combination comprises:
searching for a signal with a second PN code having a received power level above a threshold power level on the first band and channel combination; and
determining that a good sector is available on the first band and channel combination if the signal is detected.

4. The method of claim 1, wherein the first subscription is a code division multiple access (CDMA) subscription.

5. The method of claim 1, wherein the channel quality deterioration is determined by one of a max access probe exit (MAPE) and an access timeout.

6. A mobile communication device, comprising:
a communication unit; and
a control unit configured to:
cause the communication unit to access a communication network with a first subscription on a first band and channel combination using a first pseudorandom noise (PN) code;
determine if channel quality on the first band and channel combination using the first PN code has deteriorated;
in response to determining that the channel quality has deteriorated, determine if a good sector is available on the first band and channel combination;
in response to determining that a good sector is available, prevent the first band and channel combination from being placed on an avoidance list; and
cause the communication unit to hand off to the good sector using a second PN code.

7. The mobile communication device of claim 6, wherein the control unit is configured to:
in response to determining that a good sector is not available, place the first band and channel combination on the avoidance list;
perform an out-of-service scan; and
select a different band and channel combination to access the communication network with the first subscription.

8. The mobile communication device of claim 7, wherein the control unit configured to:
search for a signal with a second PN code having a received power level above a threshold power level on the first band and channel combination; and
determine that a good sector is available on the first band and channel combination if the signal is detected.

9. The mobile communication device of claim 6, wherein the first subscription is a code division multiple access (CDMA) subscription.

10. The mobile communication device of claim 6, wherein the channel quality deterioration is determined by one of a max access probe exit (MAPE) and an access timeout.

11. A non-transitory computer readable medium having stored therein instructions for causing one or more processors to perform operations including:
accessing a communication network with a first subscription on a first band and channel combination using a first pseudorandom noise (PN) code;
determining if channel quality on the first band and channel combination using the first PN code has deteriorated;
in response to determining that the channel quality has deteriorated, determining if a good sector is available on the first band and channel combination;
in response to determining that a good sector is available, preventing the first band and channel combination from being placed on an avoidance list; and
handing off to the good sector using a second PN code.

12. The non-transitory computer readable medium having stored therein instructions as defined in claim 11, the instructions further including:
in response to determining that a good sector is not available, placing the first band and channel combination on the avoidance list;
performing an out-of-service scan; and
selecting a different band and channel combination to access the communication network with the first subscription.

13. An apparatus, comprising:
means for accessing a communication network with a first subscription on a first band and channel combination using a first pseudorandom noise (PN) code;
means for determining if channel quality on the first band and channel combination using the first PN code has deteriorated;
means for in response to a determination that the channel quality has deteriorated, determining if a good sector is available on the first band and channel combination;
means for in response to determining that a good sector is available, preventing the first band and channel combination from being placed on an avoidance list if a good sector is available; and
means for handing off to the good sector using a second PN code.

14. The apparatus of claim 13, further comprising:
in response to determining that a good sector is not available, means for placing the first band and channel combination on the avoidance list;
means for performing an out-of-service scan; and
means for selecting a different band and channel combination to access the communication network with the first subscription.

15. The apparatus of claim 14, wherein the means for determining if a good sector is available on the first band and channel combination comprises:
means for searching for a signal with a second PN code having a received power level above a threshold power level on the first band and channel combination; and
means for determining that a good sector is available on the first band and channel combination if the signal is detected.

16. A method, comprising:
determining that channel quality for a first communication network on a first band and channel combination using a first pseudorandom noise (PN) code has deteriorated;
searching for a signal with a second PN code of a sector having a received power level above a threshold power level on the first band and channel combination;
in response to the signal, attempting to access the first communication network on the first band and channel combination using the second PN code;
in response to a successful access attempt:
preventing the first band and channel combination from being placed on an avoidance list; and
handing off to the sector using the second PN code.

17. The method of claim 16, further comprising:
in response to a failure to detect the signal:
placing the first band and channel combination on the avoidance list;
performing an out-of-service scan; and
selecting a different band and channel combination to access the first communication network.

18. The method of claim 16, further comprising:
in response to an unsuccessful access attempt:
placing the first band and channel combination on the avoidance list;
performing an out-of-service scan; and
selecting a different band and channel combination to access the first communication network.
